(19) United States
(12) Patent Application Publication
(10) Pub. No.: US 2005/0177800 A1
(43) Pub. Date: Aug. 11, 2005

(54) Indication-selecting device for an electronic device and an indication-selecting method

(75) Inventors: Yasuhide Suzuki, Saitama (JP); Shuzo Seo, Saitama (JP); Shinichi Kakiuchi, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/052,824

(22) Filed: Feb. 9, 2005

(30) Foreign Application Priority Data
Feb. 10, 2004 (JP) 2004-34024

(51) Int. Cl. G06F 3/00

(52) U.S. Cl. 715/823; 715/810

(57) ABSTRACT

An indication-selecting device for an electronic device includes (1) an indicator for simultaneously indicating a plurality of icons which correspond to a plurality of functions of the electronic device, and which are classified into a plurality of groups; (2) an indication-distinguishing device which distinguishes all the icons of a group which has been selected from icons in the remaining groups which are not selected; (3) a selection device for selecting a desired icon in the group which has been selected; and (4) an enabling device for enabling a function corresponding to the desired icon which is selected by the selection device.

### BACKGROUND OF THE INVENTION

1. Field of the Invention

The present invention relates to an indication-selecting device for an electronic device and an indication-selecting method.

2. Description of the Prior Art

In an electronic device such as a camera, an indication-selecting device is provided in order to select the various built-in functions of the electronic device. These built-in functions are usually indicated with icons, so that a function can be set by selecting the corresponding icon. In order to cope with an increase in the number of functions, a hierarchical layer structure (hereinafter, a layer structure) of icons is frequently employed. Accordingly, in order to reach a desired icon (function) which is on a lower layer in the layer structure, the icon(s) on a higher layer(s) have to be correctly selected.

However, such a layer structure in an indication-selecting device may not have been user friendly. For example, even a user who does not have sufficient knowledge on the electronic device may know the user's desired (target) function, i.e., the user understands which function should be selected according to photographing conditions and/or the user's intended picture composition, etc. However, if the user's desired function is on a lower layer in the layer structure, the user may not understand how the desired icon (function) on a lower layer belongs to icons on a higher layer which have to be correctly selected in order to obtain the desired icon (function). Accordingly, a large amount of time would be wasted until the user reaches the desired icon (function), unless the user understands an inter-layer relations on the upper to lower icons.

On the other hand, even if an attempt were made to uniformly indicate a lot of icons at the same time, it has been known that the desired icon would be difficult to be found and selected.

### SUMMARY OF THE INVENTION

The present invention achieves an indication-selecting device for an electronic device and an indication-selecting method, through which the selecting of icons (functions) can be more easily performed.

According to an aspect of the present invention, there is provided an indication-selecting device for an electronic device includes (1) an indicator for simultaneously indicating a plurality of icons which correspond to a plurality of functions of the electronic device, and which are classified into a plurality of groups; (2) an indication-distinguishing device which distinguishes all the icons of a group which has been selected from the icons of the remaining groups which are not selected; (3) a selection device for selecting a desired icon in the group which has been selected; and (4) an enabling device for enabling a function corresponding to the desired icon which is selected by the selection device.

When another group is selected, the indication-distinguishing device is preferably arranged to distinguish all the icons of the newly selected group from the icons of the remaining groups which are not selected.

The indication-distinguishing device preferably displays an indication frame which is arranged to surround the icons of the selected group.

The indication-distinguishing device preferably displays the icons of the selected group at a higher luminance than a luminance of the icons of the remaining groups which are not selected.

The indication-distinguishing device preferably displays the icons of the selected group at a larger size than a size of the icons of the remaining groups which are not selected.

The electronic device can be applied to a digital camera.

According to another aspect of the present invention, there is provided an indication-selecting method for an electronic device includes the steps of;
(i) simultaneously indicating a plurality of icons which correspond to a plurality of functions of the electronic device;
(ii) classifying the plurality of icons into a plurality of groups;
(iii) distinguishing all the icons of a selected group from the icons of the remaining groups which are not selected;
(iv) selecting a desired icon within the selected group; and
(v) enabling a function corresponding to the desired icon.

When another group is selected, the step of distinguishing is preferably arranged to distinguish all the icons of the newly selected (another) group from the icons of the remaining groups which are not selected.

The step of distinguishing is preferably performed by indicating an indication frame which surrounds all the icons of the selected group.

The step of distinguishing is preferably performed by displaying all the icons of the selected group at a higher luminance than a luminance of the icons of the remaining groups which are not selected.

The step of distinguishing is preferably performed by displaying all the icons of the selected group at a larger size than a size of the icons of the remaining groups which are not selected.

The present disclosure relates to subject matter contained in Japanese Patent Application No. 2004-34024 (filed on Feb. 10, 2004) which is expressly incorporated herein in its entirety.

### BRIEF DESCRIPTION OF THE DRAWINGS

The present invention will be discussed below in detail with reference to the accompanying drawings, in which:

FIG. 1 shows a rear view of a digital camera to which an indication-selecting device for an electronic device of the present invention is applied;

FIG. 2 is a block diagram showing a control system of the digital camera of FIG. 1;

FIG. 3 is an example of an indication for a LCD panel on which one group of the icons surrounded by an indication frame is selected;

FIG. 4 is another example of an indication for the LCD panel on which another group of the icons surrounded by the indication frame is selected;

FIG. 5 is a further example of an indication for the LCD panel on which the icons of the selected group are indicated at a higher luminance than a luminance of the icons of the remaining groups which are not selected;

FIG. 6 is still another example of an indication for the LCD panel on which the icons of the selected group are indicated at a larger size than a size of the icons of the remaining groups which are not selected; and

FIG. 7 is a schematic flow chart showing how a desired icon and a desired group of icons are selected.

### DESCRIPTION OF THE PREFERRED EMBODIMENTS

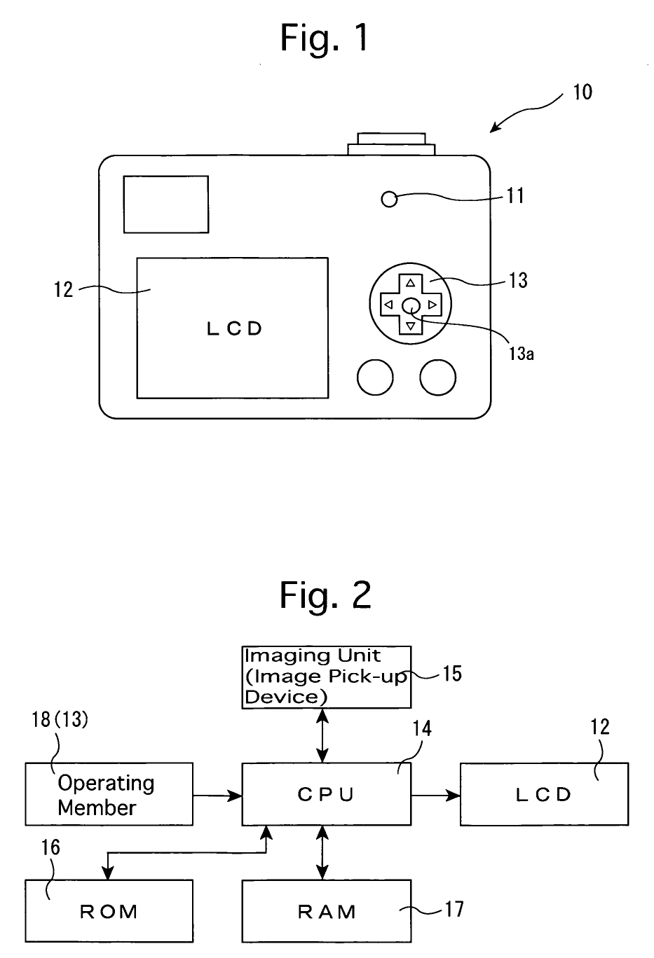

The embodiment of the present invention is applied to a digital camera 10. As shown in FIG. 1, the rear surface of the digital camera 10 is provided with a power switch 11, an LCD panel (indicator) 12, and a four-way control switch (a selection device) 13. The four-way control switch 13 has four arrow keys pointing radially outwards at 90 degree equi-angular intervals about the periphery thereof. The currently selected icon can be changed (selected) by depressing any one of the four arrow keys. The four-way control switch 13 also includes an enable (“OK”) button 13a (an enabling device) located in the center thereof for enabling the function corresponding to the selected icon. Accordingly, the four-way control switch 13 constitutes a selection/enabling switch.

The digital camera 10, as shown in FIG. 2, is provided with a CPU (a controller) 14 for controlling the LCD panel 12; an imaging unit (an image pick-up device) 15 for capturing an object image collected through a photographing lens (not shown) of the digital camera 10; a ROM 16 for beforehand storing (i) photographic-mode data, (ii) function (icon) data, (iii) function-classification data and (iv) indication-frame data; and a RAM 17 for temporarily storing imaging data.

In the photographic mode, the object image captured by the imaging unit 15 is indicated (displayed) on the LCD panel 12 via the CPU 14.

An operating member 18, which includes the four-way control switch 13, for selecting modes such as the photographic mode, a playback mode, a function selecting mode, etc., is connected to the CPU 14.

When the power switch 11 is turned ON, the CPU 14 of the digital camera 10 is arranged to automatically select the photographic mode and displays an object image, captured by the imaging unit 15, on the LCD panel 12.

In the illustrated embodiment, when the lower portion (lower arrow key) of the four-way control switch 13 is depressed during the photographic mode, the function selecting mode is set.

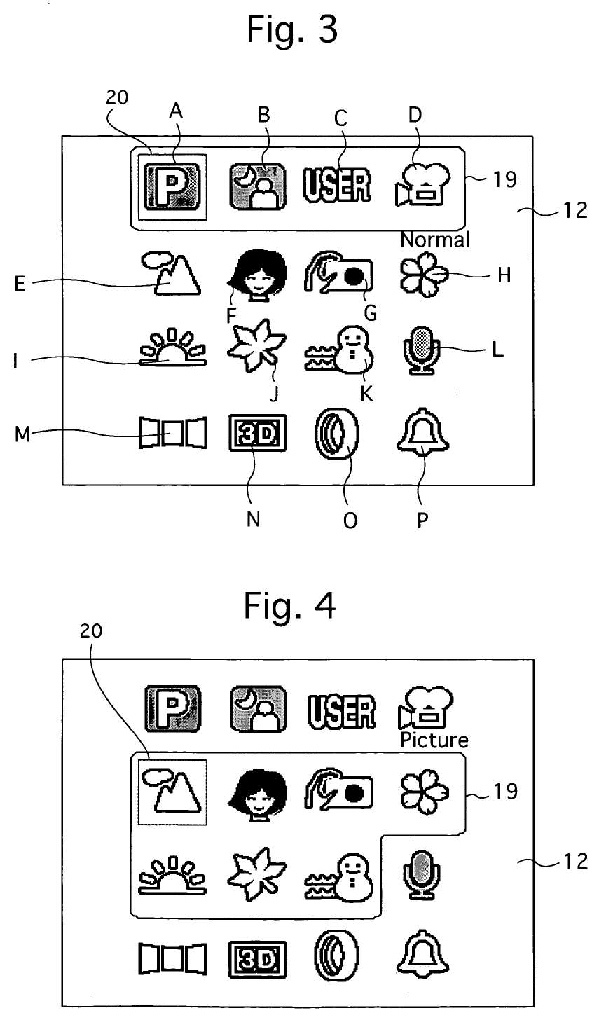

FIG. 3 is an example of an indication for the LCD panel 12, when the function selecting mode is set. In this example, the LCD panel 12 is arranged to indicate the following 16 icons (functions):
A. Standard Mode (Program Mode)
B. Night-Scene Mode
C. User's Setting Mode
D. Movie-Picture Mode
E. Landscape Mode
F. Portrait Mode
G. Self-Portrait Mode
H. Macro Mode
I. Sunset Mode
J. Autumn-Color Mode
K. Surf & Snow Mode
L. Voice Recording Mode
M. Panoramic Mode
N. 3D Mode
0. Digital Filter Mode
P. Alarm Mode

The above 16 icons (functions) A through P are in advance classified into the following three groups, and stored in the ROM 16:
First Group: A through D
Second Group: E through K
Third Group: L through P

Note that the first group (A through D) is associated with settings which are carried out before a photographing operation; the second group (E through K) is associated with settings according to the object to be captured and/or the user's intended picture composition; and the third group (L through P) is associated with special functions.

In the selecting of the indications according to the illustrated embodiment, when the function selecting mode is set (i.e., upon the lower arrow key of the four-way control switch 13 being depressed), one of the first, second and third groups can be selected by the user with the four-way control switch 13, and all the icons of the selected group are indicated so as to be distinguished from the other icons of the remaining groups which are not selected.

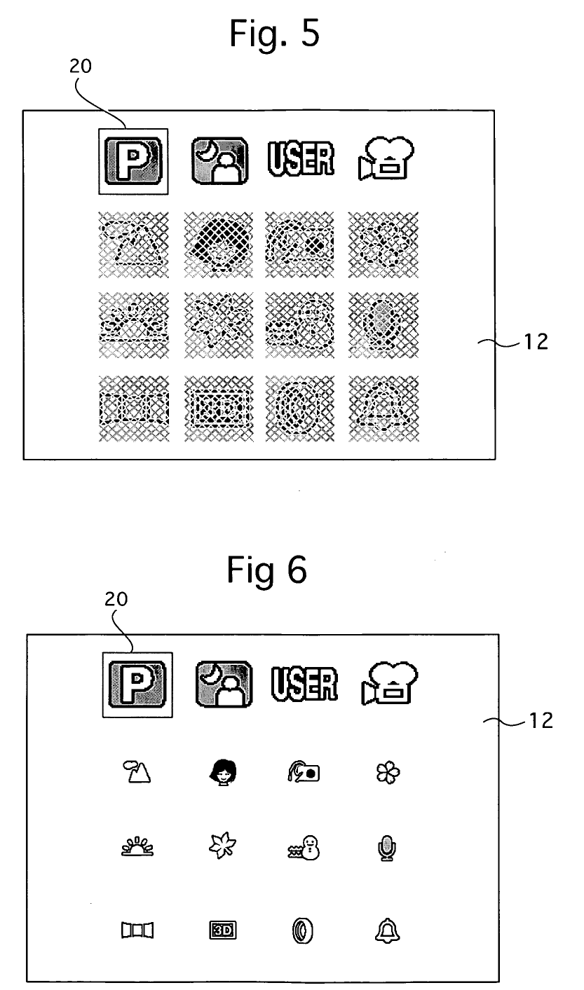

FIG. 3 shows an example in which the icons of the first group (A through D) are selected, and surrounded by an indication frame 19. If a desired icon exists within the indication frame 19, the user can select the desired icon by operating the four-way control switch 13. In regard to a way to inform that the desired icon is selected within the indication frame 19, in the case of FIG. 3, the desired (selected) icon “A” is surrounded by a small indication frame 20. Similarly, in the case of FIG. 4, the desired (selected) icon “E” is surrounded by the small indication frame 20 within the indication frame 19. Furthermore, in the case of FIGS. 5 and 6, the desired (selected) icon “A” is surrounded by the small indication frame 20.

The way to inform that the desired icon is selected is not limited to the above, e.g., it is possible to increase the luminance or change the color of the desired (selected) icon itself.

In order to enable the desired (selected) icon, the enable (‘OK’) button 13a on the center of the four-way control switch 13 is depressed.

The CPU (indication-distinguishing device) 14 controls the LCD panel 12 to display all of the icons stored in the ROM 16, and to display the icons of the selected group and those of the remaining groups which are not selected in a manner that the icons of the selected group are distinguished from the other icons of the remaining (non selected) groups according to an operation of the four-way control switch 13. Furthermore, the CPU (enabling device) 14 is arranged to set the digital camera 10 so that the selected function (icon) is enabled through the depressing of the enable button 13a, i.e., the center portion of the four-way control switch 13.

In order to change the currently selected group (e.g., the group indicated with the indication frame 19 in FIG. 3) to a next one, the user can directly select a desired icon or may select any one of icons in the next group, by depressing one(s) of the arrow keys of the four-way control switch 13.

Through the operations explained above, the next group is selected, e.g., as shown in FIG. 4 where the second group (E through K) with the indication frame 19 becomes the currently selected group.

The selection and enabling of a desired icon in the second group is carried out by the four-way control switch 13 and the enable button 13a in the same manner as explained with respect to the first group of the icons.

FIG. 5 shows an example in which the luminance of the icons of the selected group is higher than that of the icons of the remaining groups which are not selected.

FIG. 6 shows another example in which the size of the icons of the selected group is larger than the size of the icons of the remaining groups which are not selected.

In regard to an example of how the indicating of the indication frame 19 is carried out, the data of the icons and that of the indication frame 19 can individually be stored in the ROM 16; and according to a group to be selected, the data of the indication frame 19 is superimposed on the data of the icons corresponding to the group to be selected.

Similarly, in the case of FIG. 5, i.e., the luminance of the icons of the selected group is made higher than that of the icons of the remaining (non selected) groups, the data of a lower-transmittance area, instead of the data of indication frame 19, can be stored in the ROM16.

Furthermore, in the case of FIG. 6 (i.e., the size of the icons of the selected group is larger than the size of the icons of the remaining (non selected) groups), such an indication can be achieved by, for example, eliminating some of the data of the icons of the non selected groups.

In addition, a response time to change the groups of icons (from a currently selected group to another one) can be made different from a response time to change the icons in a selected group (from one icon to another in a selected group).

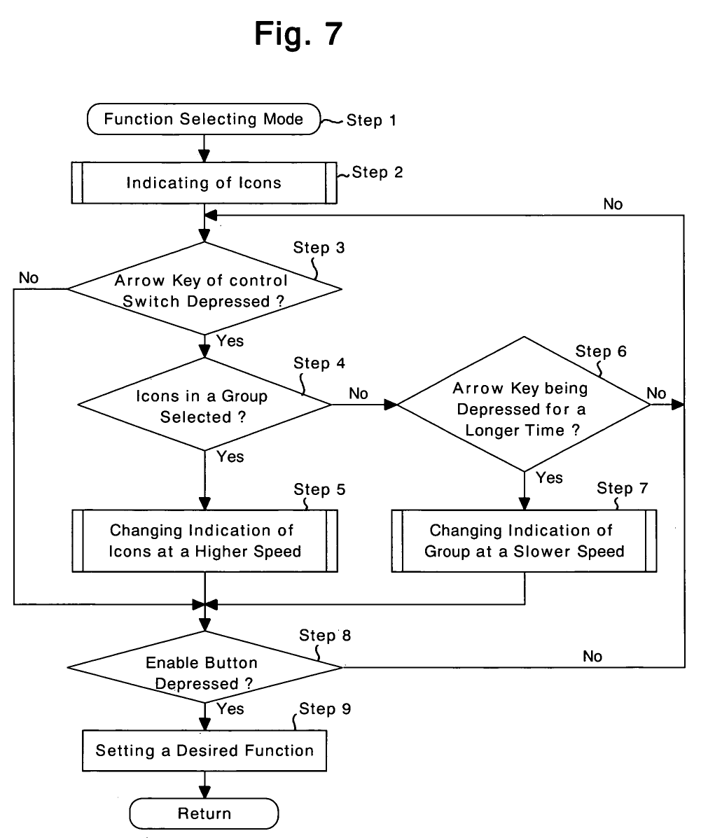

For example, the above operation can be carried out according to the schematic flow chart shown in FIG. 7.

When the lower portion (lower arrow key) of the four-way control switch 13 is depressed during the photographic mode, the function selecting mode is set (Step 1).

The icons A through P (see, e.g., FIGS. 3 and 4) are indicated on the LCD panel 12 (Step 2).

Control checks if one of the four arrow keys of the control switch 13 is depressed (Step 3).

If “Yes” at Step 3, control proceeds to Step 4.

If “No” at Step 3, control returns to Step 3 via Step 8 (explained below).

Control checks if an operation of one of the four arrow keys of the control switch 13 at Step 3 is for selecting the icons in a selected group (Step 4).

If “Yes” at Step 4, in order to select a desired icon, the indication of the icons are changed at a higher speed upon a discrete depressing of one of the four arrow keys of the control switch 13 (Step 5).

Here, note that the speed for changing the indication of the icons is made faster than a speed for changing the indication frame 19 from a currently selected group to another one (explained below).

If “No” at Step 4, control checks if an operation of the control switch 13 at Step 3 is to depress one of the four arrow keys of the control switch 13 for a longer time (Step 6).

Here, note that the time for depressing one of the four arrow keys of the control switch 13 at Step 6 is made longer than the time for discretely depressing one of the four arrow keys of the control switch 13 at Step 5.

If “Yes” at Step 6, the indicating of the indication frame 19 is changed from a currently selected group to another one (Step 7).

If “No” at Step 6, control returns to Step 3; and the operations are repeated.

At Step 7, during one of the four arrow keys of the control switch 13 is being depressed, the indication frame 19 can be arranged, for example, to alternately disappear and appear at a slower speed which is slower than the speed for changing the indication of icons at Step 5. More specifically, after the indication frame 19 for a previously selected group disappears, the indication frame 19 again appears when control detects another (next) group of icons. If the next group is a desired group, control stops the group-selecting operation. On the other hand, if not, the above operations are repeated at a slower speed until a desired group is selected.

When a desired icon in a desired group is selected, control proceeds to Step 8.

Then, control checks if the enable (“OK”) button 13a of the four-way control switch 13 is depressed (Step 8).

If “Yes” at Step 8, a desired function corresponding to the selected icon is set (Step 9).

If “No” at Step 8, control returns to Step 3; and the operations are repeated.

In the above description, the present invention is applied to the digital camera 10, while the present invention is not limited to such a digital camera. The present invention can also be generally applied to electronic devices in which various functions are indicated with icons.

According to the present invention, a desired icon (function) can be quickly and easily selected from a multiple number of functions indicated with icons in an electronic device.

1. An indication-selecting device for an electronic device, comprising:
an indicator for simultaneously indicating a plurality of icons that correspond to a plurality of functions of said electronic device, and that are classified into a plurality of groups;
an indication-distinguishing device that distinguishes all icons of a selected group from icons of the remaining groups that are not selected;
a selection device for selecting a desired icon in said selected group; and
an enabling device for enabling a function corresponding to said desired icon that is selected by said selection device.

2. The indication-selecting device for an electronic device according to claim 1, wherein when another group is selected, said indication-distinguishing device distinguishes all icons of said another group from icons of the remaining groups that are not selected.

3. The indication-selecting device for an electronic device according to claim 1, wherein said indication-distinguishing device displays an indication frame that surrounds said icons of said selected group.

4. The indication-selecting device for an electronic device according to claim 1, wherein said indication-distinguishing device displays said icons of said selected group at a higher luminance than a luminance of icons of the remaining groups that are not selected.

5. The indication-selecting device for an electronic device according to claim 1, wherein said indication-distinguishing device displays said icons of said selected group at a larger size than a size of icons in the remaining groups that are not selected.

6. The indication-selecting device for an electronic device according to claim 1, wherein said electronic device comprises a digital camera.

7. An indication-selecting method for an electronic device, comprising the steps of:
simultaneously indicating a plurality of icons that correspond to a plurality of functions of said electronic device;
classifying said plurality of icons into a plurality of groups;
distinguishing all icons of a selected group from icons of the remaining groups that are not selected;
selecting a desired icon within said selected group; and
enabling a function corresponding to said desired icon.

8. The indication-selecting method for an electronic device according to claim 7, wherein when another group is selected, said step of distinguishing is further performed to distinguish all icons of said another group from icons of the remaining groups that are not selected.

9. The indication-selecting method for an electronic device according to claim 7, wherein said step of distinguishing is performed by displaying an indication frame that surrounds said all icons of said selected group.

10. The indication-selecting method for an electronic device according to claim 7, wherein said step of distinguishing is performed by displaying said all icons of said selected group at a higher luminance than a luminance of icons of the remaining groups that are not selected.

11. The indication-selecting method for an electronic device according to claim 7, wherein said step of distinguishing is performed by displaying said all icons of said selected group at a larger size than a size of icons of the remaining groups that are not selected.
